(19) United States
(12) Patent Application Publication
(10) Pub. No.: US 2023/0249483 A1
(43) Pub. Date: Aug. 10, 2023

(54) ACCELERATED CARRIAGE WITHIN PRINT ZONES

(71) Applicant: Hewlett-Packard Development Company, L.P., Spring, TX (US)

(72) Inventors: Alex RIUS LAORDEN, Sant Cugat del Valles (ES); Jose Angel VILLASANTE BEMBIBRE, Sant Cugat del Valles (ES); Luis SOLE ENRECH, Sant Cugat del Valles (ES); Ricardo OLTRA RAMIREZ, Sant Cugat del Valles (ES)

(73) Assignee: Hewlett-Packard Development Company, L.P., Spring, TX (US)

(21) Appl. No.: 18/001,779

(22) PCT Filed: Jun. 16, 2020
(86) PCT No.: PCT/US2020/037943

§ 371 Date: Dec. 14, 2022

(51) Int. Cl. B41J 25/00

(52) U.S. Cl. CPC B41J 25/006

(57) ABSTRACT

A printing system is disclosed herein. The system comprises a controller and a carriage moveable along a width of a print zone, the carriage includes a printhead to eject a printing fluid on a plot area within the print zone based on print job data. The controller is to receive a print job data; define a post-processing time based on the print job data; and define a time between two consecutive swaths of the carriage based on the post-processing time. The controller is further to define a ramp area and a plot area within the print zone based on the print job data, wherein the plot area includes locations in which the printing fluid is to be ejected. The controller is also to control the carriage to move at a constant speed at the plot area and at an accelerated speed at the ramp area.

### BACKGROUND

Printers and 3D printers are devices that record images on a media. These printers comprise printheads in a carriage that selectively propel an amount of printing fluid on the media. Some printers may include internal printing fluid reservoirs. Other printers may use external printing fluid cartridges as printing fluid reservoirs.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a printing system comprising a moveable carriage;

FIG. 2 is a flowchart of an example method for controlling a moveable carriage of a printing system;

FIG. 3A is a schematic diagram of another example of a printing system comprising a moveable carriage;

FIG. 3B is a schematic diagram of another example of a printing system comprising a moveable carriage;

FIG. 3C is a schematic diagram of another example of a printing system comprising a moveable carriage;

FIG. 4 is a schematic diagram showing an example of a printing system including a service area and comprising a moveable carriage;

FIG. 5 is a schematic diagram showing an example of a printing system including a post-processing area and comprising a moveable carriage; and

FIG. 6 is a block diagram showing a processor-based system example of a printing system.

### DETAILED DESCRIPTION

The following description is directed to various examples of 2D printing systems or additive manufacturing systems (3D printing systems). Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and may perform the same functionality.

Printers comprise a carriage having elements to selectively propel an amount of printing fluid on a media. In some printers, the carriage is a fixed carriage spanning at least the full width of the printable area of the media, so that as the media travels underneath, the elements from the carriage propel the printing fluid and thereby generate the image to be recorded. In other examples, however, the carriage is a moveable carriage that does not span the full width of the printable area of the media. The scanning carriage is therefore controllable to scan across the full width of the printable area of the media and to selectively propel the printing fluid on the media.

The speed and position of the scanning carriage may be controlled by a set of electronic components, such as a processor, a CPU, a SoC, a FPGA, a PCB and/or a controller. In some examples, different stages of the speed control may be executed by different of the aforementioned electronic components.

When a scanning carriage accelerates and brakes, it generates a tension peak that may damage elements of the electronic components that control the carriage; such elements may be for example capacitors. The damage of capacitors may cause thermal stress which may reduce the lifetime of the electronic components exponentially. In the present disclosure, the term acceleration may be understood as the rate of change of the speed (i.e., velocity) of the scanning carriage with respect to time. A positive acceleration is indicative of an incremental change of the speed. A negative acceleration is indicative of a decremental change of the speed, i.e. carriage brakes.

The largest the absolute value of the acceleration of the carriage at a given time, the largest the tension peak it may cause to the electronic components and, thereby, the largest of the lifetime reduction of the electronic components. Therefore, reducing the absolute value of the acceleration of the carriage may lead to an extension of the lifetime of the electronic components that control the speed of the carriage.

Some printing systems may also include a post-processing operation, such as a printing fluid curing operation associated with each swath of the carriage that may take time to execute (i.e. post-processing time). In the examples herein, a swath is the movement of the carriage associated with a width of the printable area of the media. In some examples, the swath may not involve the full width of the printable area of the media. Accordingly, a swath time may be understood as the time to execute a swath. The swath time between different swaths may be of different durations. Therefore, the swath time may be determined based on the post-processing time, e.g., the swath time may be calculated as the minimum swath time that allows for an adequate performance of the post-processing operation, i.e., the post-processing time. However, as mentioned above, controlling the carriage to move at large accelerations to cope with the minimum duration of the swath time may lead to an exponential lifetime reduction of the electronic components that control the carriage speed.

On top of the previous, printer users may define throughput requirements in which the printer record a print job of images. The throughput requirements may be based on a time requirement. The carriage may therefore be controlled to move fast enough to satisfy the throughput requirements of the user and slow enough to cope with the post-processing time and to leverage the lifetime reduction of the electronic components.

In the examples herein, the terms “width” and “length” have been used. The two terms are intended to denote two substantially orthogonal directions within a horizontal plane. In the examples, the length may be referred to as the direction corresponding to the illustrated axis X, and the width may be referred to as the direction corresponding to the illustrated axis Y. In further examples, the terms width and length may be used interchangeably.

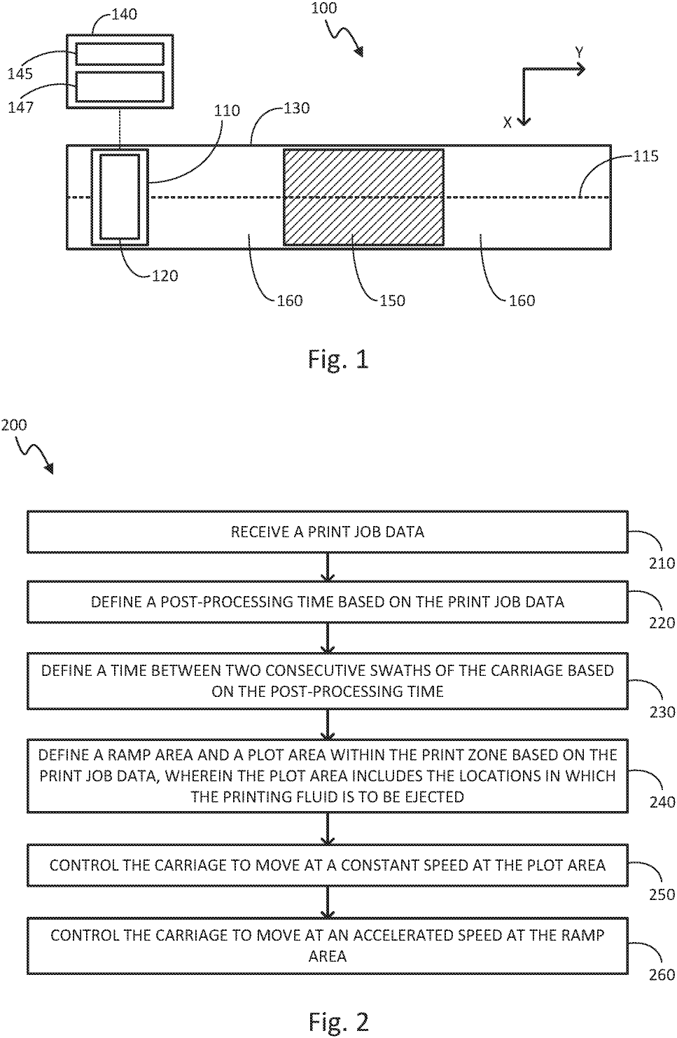

Referring now to the drawings, FIG. 1 is a schematic diagram showing an example of a printing system 100 comprising a moveable carriage 110. The printing system 100 may be any printing system with a scanning carriage suitable for recording images on a media (not shown). Some examples of the printing system 100 may include a desk printer, a large format printer, or a 3D printer.

The printing system 100 comprises a carriage 110 moveable along a width of a print zone 130 (i.e., through print axis 115). In the examples herein, the print zone 130 may be understood as the area in which a media (not shown for simplicity) is potentially printable. In some examples, such as during transportation, the printing system 100 does not comprise the media. In other examples, such as in use, the printing system 100 comprises the media. The media may be any suitable material to be recorded thereon such as paper, plastic, textile, metal, cardboard, wood, additive manufacturing build material including plastics and metals; and the like.

The printing system 100 may receive print job data, which may be a digital product including the images and/or text to be recorded on the media. The print job data may be received in a plurality of digital formats, such as JPEG, TIFF, PNG, PDF and the like.

The carriage 110 includes a printhead 120 to eject a printing fluid on a plot area 150 within the print zone 130. The printhead 120 is to selectively eject the printing fluid based on the print job data. The plot area 150 is therefore the part of the print zone 130 that constitutes the images and/or text from the print job. The remaining parts of the print zone 130 that are not the plot area 150 may be referenced herein as ramp area 160. In some examples, there may be a plurality of plot areas 150 and a plurality of ramp areas 160 within the print zone 130.

In some examples, the printhead 120 may eject a plurality of printing fluids. A printing fluid may be a solution of pigments dispersed in a liquid carrier such as water or oil. Some recording printing fluids may include Black ink, White ink, Cyan ink, Yellow ink, Magenta ink, Red ink, Green ink, and/or Blue ink. Other non-recording printing fluids may be used to provide additional properties to the printing fluids ejected on the plot area 150, for example, resistance to light, heat, scratches, and the like.

The printing system 100 further comprises a controller 140 coupled to the carriage 110. The controller 140 may be any electronic element suitable for controlling the speed of the carriage 110. In the example, the controller 140 comprises a processor 145 and a memory 147 with specific control instructions to be executed by the processor 145. The functionality of the controller 140 is described further below with reference to FIG. 2.

In the examples herein, the controller 140 may be any combination of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller 150 may be, at least partially, implemented in the form of an electronic circuitry. The controller 150 may be a distributed controller, a plurality of controllers, and the like.

FIG. 2 is a flowchart of an example method 200 for controlling a moveable carriage 110 of a printing system, for example the printing system 100 of FIG. 1. The method 200 may involve previously disclosed elements from FIG. 1 referred to with the same reference numerals. In some examples, method 100 may be executed by the controller 140.

At block 210, the controller 140 receives print job data including the images and/or text to be recorded on the media. The controller 140, at block 220, defines a post-processing time based on the print job data. In an example, the post-processing time may be the time to dry, cure or sublimate the recorded image corresponding to a swath. In another example, the post-processing time may be the time to execute a media cut along the width of the media. In yet another example, the post-processing time may be the time to fold an amount of media in, for example, a stacked manner.

At block 230, the controller 140 defines a time between two consecutive swaths (i.e., swath time) based on the post-processing time. Additionally, in some examples, the controller 140 determines a media advancement speed (e.g., movement of the media along positive axis X), substantially perpendicular to the scanning movement of the carriage 110 (i.e., print axis 115 along positive and negative axis Y). The controller 140 may determine the media advancement speed based on the post-processing time, so that the post-processing operation is completed prior to a further advancement of the media. The controller 140 may then define the time between two consecutive swaths of the carriage 110 (i.e., swath time) based on the media advancement time so that the carriage 110 executes at least a swath in a predetermined amount of media advancement, and thereby each addressable location of the print zone 130 may potentially be recorded with printing fluid.

At block 240, the controller 140 defines the ramp area 160 and the plot area 150 within the print zone 130 based on the print job data. The plot area 150 includes the locations on the media in which the printing fluid is to be ejected to record the images and/or text encoded in the print job data. The ramp area 160 corresponds to the locations from the print zone 130 other than the plot area 150.

In some examples, the plot area 150 width is narrower than the full width of the plot area 150. In some of these examples, the controller 140 may define the plot area 150 substantially at the middle of the print zone 130 so that the ramp areas 160 located at both sides of the plot area 150 are of substantially the same width (see, e.g., illustrated configuration in FIG. 1). In another of these examples, the controller 140 may define the plot area 150 at substantially a distal end of the width of the print zone 130 so that a single ramp area 160 is located in the area defined from the other end of the width of the print zone 130 to the plot area 150.

At block 250, the controller 140 controls the carriage 110 to move at a constant speed at the plot area 150. At block 260, however, the controller 140 controls the carriage 110 to move at an accelerated speed at the ramp area 160 from the print zone 130. The carriage is therefore controlled to move within the print zone 130 at a constant speed (i.e., nil acceleration) at the plot area 150 and at an accelerated speed (e.g. positive or negative accelerated speed) at the ramp area 160.

In an example, the constant speed of the carriage 110 at the ramp area is substantially the fastest speed within a swath in which the carriage 110 moves. In this example, the movement of the carriage 110 in a swath may be as follows. The carriage accelerates from a zero-velocity point located at the ramp area 160 and towards the plot area 150. At the plot area 150 the speed is maximum and becomes constant throughout the width of the plot area 150. Once the carriage leaves the plot area 150, the controller 140 may control the carriage 110 to break (i.e., negative acceleration) away from the plot area 150 until a zero-velocity point located at the ramp area 160 is reached.

In some examples, the controller 140 may control the acceleration of the carriage to reduce the maximum absolute value of the acceleration at any point of the swath. The acceleration of the carriage may be constrained by the maximum width of the ramp area 160. In an example, the controller 140 reduces the maximum absolute value of the acceleration by increasing the time in which the carriage accelerates and brakes, which may lead to a swath time increase. The controller 140 may additionally reduce the time in which the carriage 110 is at a zero-velocity point in between swaths. In some examples, the controller 140 controls the carriage 110 to be substantially no time in a zero-velocity point between swaths. To reduce the maximum absolute value of the acceleration, the controller 140 may control the carriage 110 to move at a constant accelerated speed from the zero-velocity point to the plot area 150 and from the plot area 150 to a zero-velocity point.

As mentioned above, the printing system 100 user may define a throughput requirement which may be the maximum time in which the print job is to be completed. The throughput requirement may imply a maximum swath time. In some examples, the controller 140 is to define or is to receive an acceleration threshold indicative of an excessive electrical stress. The controller 140 may then define an acceleration pattern of the accelerated speed, absolute value of which is to be below the acceleration threshold. If controlling the carriage 110 at the defined acceleration implies that the swath time is below the maximum swath time, the controller 140 may control the carriage 110 to move at the defined acceleration or at a lower acceleration. Otherwise, if controlling the carriage 110 at the defined acceleration implies that the swath time is above the maximum swath time, the controller 140 may control the carriage 110 to move at an acceleration above the defined acceleration. If such acceleration is above the acceleration threshold, the controller 140 may alert the user through a peripheral outcome device such as a screen. In the alert, the controller 140 may let the user decide whether to lose the throughput requirement (i.e., increase of maximum swath time); or to continue printing with the actual settings which may involve a lifetime reduction of the controller 140.

Additionally, in some examples, the controller 140 is further to control the printhead 120 to selectively eject the printing fluid on the plot area 150 based on the print job data and based on the position of the carriage 110.

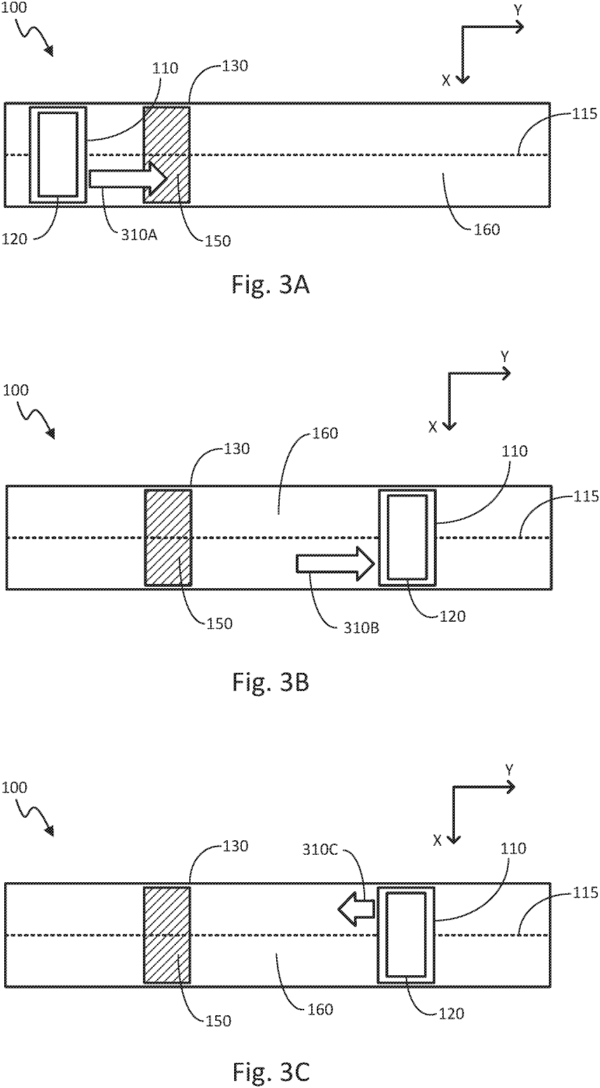

FIGS. 3A-3C illustrate examples of different positions of a moveable carriage 110 within the printing system, for example the printing system 100 of FIG. 1. The printing system may involve previously disclosed elements from FIG. 1 referred to with the same reference numerals.

FIG. 3A shows a first position of the carriage 110 corresponding to the starting point of a first swath. The controller 140 (not shown) may control the carriage 110 to accelerate from a zero-velocity state towards the plot area 150 (i.e., direction according to axis +Y) thereby moving the carriage 110 at an incremental speed (arrow 310A - positive acceleration). Once the carriage 110 reaches the plot area 150, the controller 150 may control the carriage 110 to move at a constant speed (no acceleration) throughout the plot area 150 width in which the printhead 120 may selectively eject the printing fluid based on the print job data.

At FIG. 3B, once the carriage 110 has travelled throughout the plot area 150 width, the controller 140 may control the carriage 110 to brake (i.e., negative acceleration) thereby moving the carriage 110 at a decremental speed (arrow 310B) up to a zero-velocity point. The zero-velocity point is indicative of the end of the first swath. The zero-velocity point corresponds to the inter-swath location, being a location of null velocity between two consecutive swaths. In addition to the acceleration control instructions defined above, in some examples, the controller 140 may further control the acceleration and/or the speed of the carriage 110 so that the inter-swath location falls within the print zone 130. In other examples, the controller 140 may control the acceleration and the speed of the carriage 110 so that the inter-swath location falls out of the print zone 130 (e.g., service area).

At FIG. 3C, the controller 140 controls the carriage 110 to start a second swath by accelerating from the zero-velocity point towards the plot area 150 (i.e., direction according to axis -Y) thereby moving the carriage 110 at an incremental speed (arrow 310C).

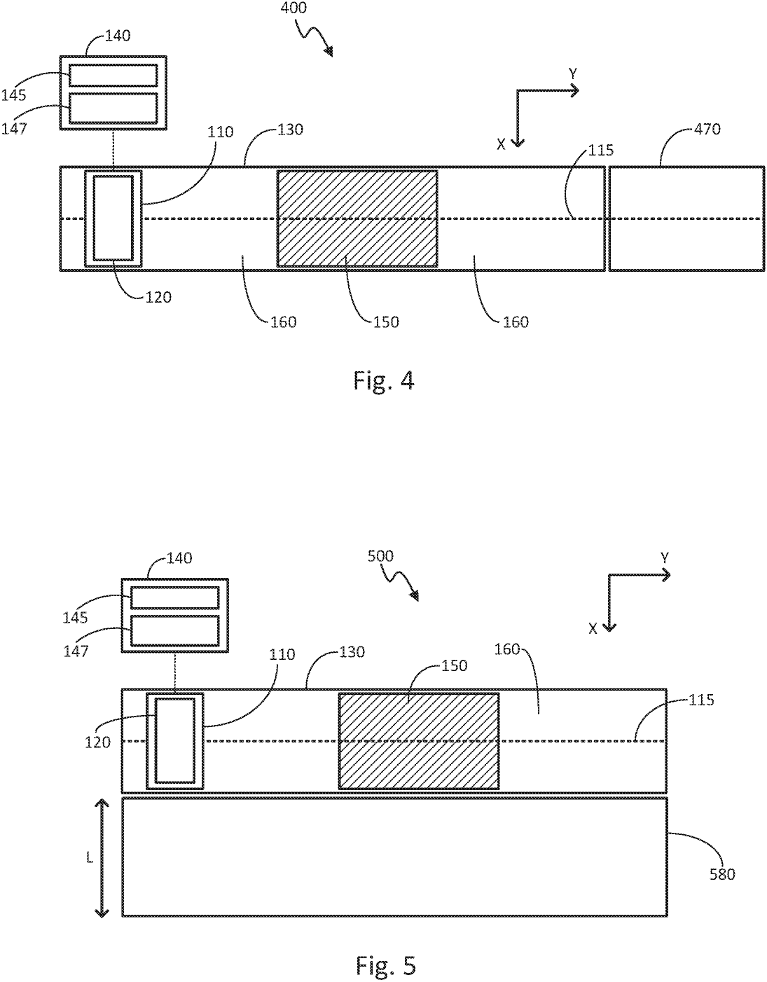

FIG. 4 is a schematic diagram showing an example of a printing system 400 including a service area 470. The printing system 400 may involve previously disclosed elements from FIG. 1 referred to with the same reference numerals. The printing system 400 comprises the carriage 110, the printhead 120, the print area 130 and the controller 140.

The printing system 400 comprises a service area 470 located adjacent to the print zone 130. In some additional examples, the printing system 400 comprises an independent service area 470 adjacent to both opposite sides of the print zone 130. The service area 470 may be aligned with the print axis 115.

The service area 470 is an area in which service operations of the printheads 120 may be executed. In some examples, the service area 470 comprises a wiping element to wipe the surface of the nozzles. In other examples, the service area 470 comprises a spittoon in which the printhead 120 nozzles eject printing fluid to avoid crusting in the nozzles. In yet other examples, the service area 470 comprises air blowing devices which apply an airflow for temperature control purposes. The service area 470 comprises a service area width in which the carriage 110 may move therethrough (i.e., axis Y).

In some examples, the controller 114 is to define the ramp area 160 to include the additional width of the service area 470 and thereby control the carriage 110 to move at a controlled acceleration taking the service area 470 width into consideration. This may reduce the maximum absolute value of the acceleration of the carriage 110.

The printhead 120 may perform a service operation at the service area 470, for example, in a periodic manner. The controller 140 may therefore receive data corresponding to the service operation to be completed by the printhead 120 and control the carriage accelerated speed (i.e., brake) based on the service operation data. In the example, since the service operation may be completed at the service area 470, the controller 140 may control the carriage 110 acceleration so that the inter-swath location falls within the service area 470 and thereby reduce the maximum absolute value of the acceleration of the carriage 110.

FIG. 5 is a schematic diagram showing an example of a printing system 500 including a post-processing area 582. The printing system 500 may involve previously disclosed elements from FIG. 1 referred to with the same reference numerals. The printing system 500 comprises the carriage 110, the printhead 120, the print area 130 and the controller 140.

The printing system 500 further comprises the post-processing area 582 located downstream the print zone 130 with respect to the media advancement direction (i.e., axis +X). The length and the elements of the post-processing area 582 may be different based on the post-processing operation to be executed.

In some examples, the post-processing operation is a drying, curing or a sublimation operation. In the examples herein, the term drying may be interpreted as the operation of applying energy to remove, at least in part, a liquid carrier from the printing fluid ejected to the media; the term curing may additionally involve the polymerization of the printing fluid on the media; and the term sublimation may be interpreted as applying energy to directly turn some elements from the printing fluid (e.g., pigments) from solid state to gas state without an intermediate liquid state phase. In these examples, the post-processing time defined by the controller 140 (see, e.g., block 220 from FIG. 2) is the time to dry, cure or sublimate the printing fluid corresponding to a swath of the carriage 110. The controller 140 may define the time to dry, cure or sublimate the printing fluid based on the composition and/or the amount of printing fluid ejected in the corresponding swath to be dried, cured, sublimated or otherwise post-processed. Additionally, in some examples, the controller 140 may further define the time to dry, cure or sublimate the printing fluid based on the length of the post-processing area 580 (illustrated as reference L).

In other examples, the post-processing operation is a cutting operation in which a cutting element cuts the media along its width. In these examples, the post-processing time defined by the controller 140 is the time to cut a media width of the media.

In yet other examples, the post-processing operation is a folding operation in which a folding mechanism folds the media at predeterminable length of the media. In these examples, the post-processing time defined by the controller 140 is the time to fold such predeterminable length of a media in, for example, a stacked manner.

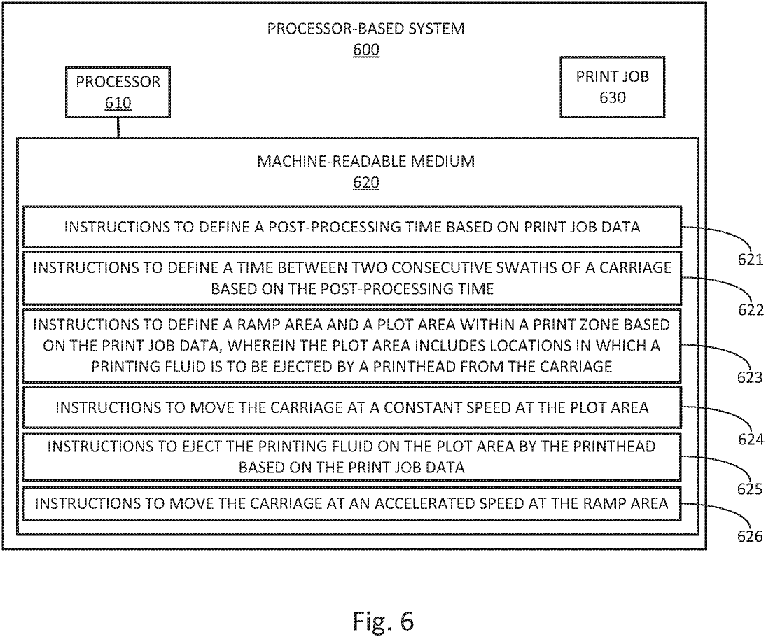

FIG. 6 is a block diagram showing a processor-based system 600 to control the movement of a carriage 110. In some implementations, the system 600 may be or may form part of a printing system, such as the printing system 100. In some implementations, the system 600 is a processor-based system and may include a processor 610 coupled to a machine-readable medium 620. The processor 610 may include a single-core processor, a multi-core processor, an application-specific integrated circuit (ASIC), a field programmable gate array (FPGA), and/or any other hardware device suitable for retrieval and/or execution of instructions from the machine-readable medium 620 (e.g., instructions 621-626) to perform functions related to various examples. Additionally, or alternatively, the processor 610 may include electronic circuitry for performing the functionality described herein, including the functionality of instructions 621-626. With respect of the executable instructions represented as boxes in FIG. 6, it should be understood that part or all of the executable instructions and/or electronic circuits included within one box may, in alternative implementations, be included in a different box shown in the figures or in a different box not shown.

The machine-readable medium 620 may be any medium suitable for storing executable instructions, such as a random-access memory (RAM), electrically erasable programmable read-only memory (EEPROM), flash memory, hard disk drives, optical disks, and the like. In some example implementations, the machine-readable medium 620 may be a tangible, non-transitory medium, where the term “non-transitory” does not encompass transitory propagating signals. The machine-readable medium 620 may be disposed within the processor-based system 600, as shown in FIG. 7, in which case the executable instructions may be deemed “installed” on the system 600. Alternatively, the machine-readable medium 620 may be a portable (e.g., external) storage medium, for example, that allows system 600 to remotely execute the instructions or download the instructions from the storage medium. In this case, the executable instructions may be part of an “installation package.” As described further herein below, the machine-readable medium may be encoded with a set of executable instructions 621-626.

The machine-readable medium 620 is to receive a print job 630 to be printed using a printing fluid, e.g. water-based ink. Instructions 621, when executed by the processor 610, may cause the processor 610 to define a post-processing time based on the print job data 630. Instructions 622, when executed by the processor 610, may cause the processor 610 to define a time between two consecutive swaths of a carriage 110 based on the post-processing time. Instructions 623, when executed by the processor 610, may cause the processor 610 to define a ramp area 160 and a plot area 150 within a print zone 130 based on the print job data 630, wherein the plot area 150 includes locations in which a printing fluid is to be ejected by a printhead 120 from the carriage 110. Instructions 624, when executed by the processor 610, may cause the processor 610 to move the carriage 110 at a constant speed at the plot area 150. Instructions 625, when executed by the processor 610, may cause the processor 610 to eject the printing fluid on the plot area 150 by the printhead 120 based on the print job data 630. Instructions 626, when executed by the processor 610, may cause the processor 610 to move the carriage 110 at an accelerated speed at the ramp area 160.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor.” The processes, method and functional modules are implemented as machine-readable instructions executable by at least one processor, hardware logic circuitry of the at least one processor, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A printing system comprising:
a carriage moveable along a width of a print zone, the carriage to include
   a printhead to eject a printing fluid on a plot area within the print zone based on print job data; and
   a controller to:
      receive a print job data;
      define a post-processing time based on the print job data;
      define a time between two consecutive swaths of the
         carriage based on the post-processing time;
      define a ramp area and a plot area within the print zone based on the print job data, wherein the plot area includes locations in which the printing fluid is to be ejected;
      control the carriage to move at a constant speed at the plot area; and
      control the carriage to move at an accelerated speed at the ramp area.

Feature set 2: A printing system with feature set 1, wherein the controller is further to: (i) determine a media advancement speed based on the post-processing time; and (ii) define the time between two consecutive swaths of the carriage based on media advancement time.

Feature set 3: A printing system with any preceding feature set 1 to 2, wherein the controller is to define an acceleration of the accelerated speed as a constant acceleration.

Feature set 4: A printing system with any preceding feature set 1 to 3, wherein the controller is to define an acceleration of the accelerated speed to be below an acceleration threshold indicative of an excessive electrical stress.

Feature set 5: A printing system with any preceding feature set 1 to 4, wherein the controller is to control the speed of the carriage so that an inter-swath location of the carriage is within the print zone.

Feature set 6: A printing system with any preceding feature set 1 to 5, wherein the carriage is further moveable along the width of a service area located adjacent to the print zone and the controller is to define the ramp area to include the additional width of the service area.

Feature set 7: A printing system with any preceding feature set 1 to 6, wherein the controller is further to: (i) receive service data corresponding to a service operation of the printhead; and (ii) control the accelerated speed of the carriage based on the service data.

Feature set 8: A printing system with any preceding feature set 1 to 7, wherein the controller is to define the plot area substantially at the middle of the print zone.

Feature set 9: A printing system with any preceding feature set 1 to 8, wherein a post-processing operation is a drying, curing or sublimation operation and the post-processing time is the time to dry, cure or sublimate the printing fluid corresponding to a swath of the carriage.

Feature set 10: A printing system with any preceding feature set 1 to 9, wherein the post-processing time is based on the composition and/or the amount of printing fluid.

Feature set 11: A printing system with any preceding feature set 1 to 10, wherein a post-processing operation is a cutting operation and the post-processing time is the time to cut a media width of a media.

Feature set 12: A printing system with any preceding feature set 1 to 11, wherein a post-processing operation is a folding operation and the post-processing time is the time to fold a predeterminable length of a media.

Feature set 13: A method comprising:
defining a post-processing time based on a print job data;
defining a time between two consecutive swaths of a carriage based on the post-processing time;
defining a ramp area and a plot area within a print zone based on the print job data, wherein the plot area includes locations in which a printing fluid is to be ejected by a printhead from the carriage;
controlling the carriage to move at a constant speed at the plot area; and
controlling the carriage to move at an accelerated speed at the ramp area.

Feature set 14: A method with feature set 13, further comprising defining an acceleration of the accelerated speed to be below an acceleration threshold indicative of an excessive electrical stress.

Feature set 15: A non-transitory machine readable medium storing instructions executable by a processor, the non-transitory machine-readable medium comprising:
instructions to define a post-processing time based on a print job data;
instructions to define a time between two consecutive swaths of a carriage based on the post-processing time;
instructions to define a ramp area and a plot area within a print zone based on the print job data, wherein the plot area includes locations in which a printing fluid is to be ejected by a printhead from the carriage;
instructions to move the carriage at a constant speed at the plot area;
instructions to eject the printing fluid on the plot area by the printhead based on the print job data; and
instructions to move the carriage at an accelerated speed at the ramp area.

1. A printing system comprising:
a carriage moveable along a width of a print zone, the carriage to include a printhead to eject a printing fluid on a plot area within the print zone based on print job data; and
a controller to:
receive a print job data;
define a post-processing time based on the print job data;
define a time between two consecutive swaths of the carriage based on the post-processing time;
define a ramp area and a plot area within the print zone based on the print job data, wherein the plot area includes locations in which the printing fluid is to be ejected;
control the carriage to move at a constant speed at the plot area; and
control the carriage to move at an accelerated speed at the ramp area.

2. The printing system of claim 1, wherein the controller is further to:
determine a media advancement speed based on the post-processing time; and
define the time between two consecutive swaths of the carriage based on media advancement time.

3. The printing system of claim 1, wherein the controller is to define an acceleration of the accelerated speed as a constant acceleration.

4. The printing system of claim 1, wherein the controller is to define an acceleration of the accelerated speed to be below an acceleration threshold indicative of an excessive electrical stress.

5. The printing system of claim 1, wherein the controller is to control the speed of the carriage so that an inter-swath location of the carriage is within the print zone.

6. The printing system of claim 1, wherein the carriage is further moveable along the width of a service area located adjacent to the print zone and the controller is to define the ramp area to include the additional width of the service area.

7. The printing system of claim 6, wherein the controller is further to:
receive service data corresponding to a service operation of the printhead; and
control the accelerated speed of the carriage based on the service data.

8. The printing system of claim 1, wherein the controller is to define the plot area substantially at the middle of the print zone.

9. The printing system of claim 1, wherein a post-processing operation is a drying, curing or sublimation operation and the post-processing time is the time to dry, cure or sublimate the printing fluid corresponding to a swath of the carriage.

10. The printing system of claim 9, wherein the post-processing time is based on the composition and/or the amount of printing fluid.

11. The printing system of claim 1, wherein a post-processing operation is a cutting operation and the post-processing time is the time to cut a media width of a media.

12. The printing system of claim 1, wherein a post-processing operation is a folding operation and the post-processing time is the time to fold a predeterminable length of a media.

13. A method comprising:
defining a post-processing time based on a print job data;
defining a time between two consecutive swaths of a carriage based on the post-processing time;
defining a ramp area and a plot area within a print zone based on the print job data, wherein the plot area includes locations in which a printing fluid is to be ejected by a printhead from the carriage;
controlling the carriage to move at a constant speed at the plot area; and
controlling the carriage to move at an accelerated speed at the ramp area.

14. The method of claim 13, further comprising defining an acceleration of the accelerated speed to be below an acceleration threshold indicative of an excessive electrical stress.

15. A non-transitory machine readable medium storing instructions executable by a processor, the non-transitory machine-readable medium comprising:
instructions to define a post-processing time based on a print job data;
instructions to define a time between two consecutive swaths of a carriage based on the post-processing time;
instructions to define a ramp area and a plot area within a print zone based on the print job data, wherein the plot area includes locations in which a printing fluid is to be ejected by a printhead from the carriage;
instructions to move the carriage at a constant speed at the plot area;
instructions to eject the printing fluid on the plot area by the printhead based on the print job data; and
instructions to move the carriage at an accelerated speed at the ramp area.
